(19) United States
(12) Patent Application Publication
(10) Pub. No.: US 2014/0249955 A1
(43) Pub. Date: Sep. 4, 2014

(54) INFORMATION PROCESSING APPARATUS, INFORMATION PROCESSING METHOD, INFORMATION PROCESSING PROGRAM, AND RECORDING MEDIUM

(71) Applicant: Takashi Yokomichi, Shinagawa-ku (JP)

(72) Inventor: Takashi Yokomichi, Shinagawa-ku (JP)

(73) Assignee: RAKUTEN, INC., Tokyo (JP)

(21) Appl. No.: 14/348,285

(22) PCT Filed: Apr. 2, 2012
(86) PCT No.: PCT/JP2012/058895

§ 371 Date: Mar. 28, 2014

(30) Foreign Application Priority Data
Sep. 30, 2011 (JP) 2011-215974

(51) Int. Cl. G06Q 30/06

(52) U.S. Cl. CPC G06Q 30/0633
USPC 705/26.8

(57) ABSTRACT

A list of a plurality of transaction objects is displayed suitably for a user according to a user's interest. An information processing apparatus includes: a specifying means that specifies transaction objects whose reference list registration information or reference list deletion information is stored in a storing means that stores at least one of the reference list registration information indicating transaction objects registered by a user in a reference list holding a reference to information on transaction objects and the reference list deletion information indicating transaction objects deleted from the reference list by the user, among a plurality of transaction objects to be listed in response to a request from a user; and a controlling means that controls a display mode in a list of the transaction objects specified by the specifying mean.

### TECHNICAL FIELD

The present invention relates to the technical field of information processing apparatuses that display a list of transaction objects.

### BACKGROUND ART

Conventionally, there have been known electronic commerce websites allowing purchase of transaction objects, such as purchase of items or reservation of services. In such websites, there is a case where a web page for a list of transaction objects is displayed in response to a request from a user. For example, such a web page may be a page that displays a retrieval result of transaction objects satisfying a condition designated by a user, or a page that displays a list of transaction objects treated as specials. For example, the user can select a transaction object in which the user is interested from the displayed list, and browse detailed information of the transaction object. Then, the user reviews transaction objects to be purchased, based on the information of the transaction objects.

In the general displaying of the list of transaction objects, the display mode (for example, display ranking, display type, and the like) of each transaction object in the list of transaction objects is basically identical with respect to all users. Therefore, since the list of transaction objects is uniformly displayed, it cannot be said that it is displayed suitably for each user. That is, since the list of transaction objects is not displayed according to the user's interest. Thus, for example, when reviewing the transaction objects to be purchased, it cannot be necessarily said that the list of transaction objects is a list easy to use by the user.

In this regard, Non Patent Literature 1 discloses a technique for retrieving hotels. In this technique, a user can add a hotel from a list of retrieval result to a shortcut list. After that, when the user designates a retrieval condition and retrieves hotels, hotel information added to the shortcut list is displayed in not a region within the list of retrieval result but another region.

### PRIOR ART LIST

### Non Patent Literature

Non Patent Literature 1: Google Inc., “Google Hotel Finder”, [online], [Retrieved on Aug. 30, 2011], Internet <URL: http://www.google.com/hotelfinder/>

### SUMMARY OF THE INVENTION

### Problem to be Solved by the Invention

However, in the technique disclosed in Non Patent Literature 1, the hotel information added to the shortcut list is displayed over the retrieval result, which interrupts the browsing of the retrieval result. Also, the list of retrieval result itself is not displayed according to the user's interest.

The present invention has been made in view of the above respects and is directed to provide an information processing apparatus, an information processing method, an information processing program, and a recording medium, which can display a list of a plurality of transaction objects suitably for a user according to a user's interest.

### Means for Solving the Problem

In order to solve the above problem, the invention according to claim 1 is an information processing apparatus comprising:

a specifying means that specifies transaction objects whose reference list registration information or reference list deletion information is stored in a storing means that stores at least one of the reference list registration information indicating transaction objects registered by a user in a reference list holding a reference to information on transaction objects and the reference list deletion information indicating transaction objects deleted from the reference list by the user, among a plurality of transaction objects to be listed in response to a request from the user; and

a controlling means that controls a display mode in the list of the transaction objects specified by the specifying means.

According to this invention, it is highly probable that the transaction objects registered in the reference list are transaction objects in which the user is interested, and it is highly probable that the transaction objects deleted from the reference list are transaction objects in which the user lost interest. Therefore, the list of the plurality of transaction objects can be displayed suitably for the user according to the user's interest.

The invention according to claim 2 is the information processing apparatus according to claim 1,

wherein the storing means stores transaction object information indicating transaction objects registered in the reference list of the user as the reference list registration information among a plurality of transaction objects retrieved based on a retrieval condition designated by the user, and the retrieval condition in association with each other,

the specifying means specifies transaction objects whose transaction object information is stored in association with a retrieval condition different from the corresponding retrieval condition, from transaction objects whose reference list registration information is stored in the storing means among transaction objects retrieved based on the retrieval condition designated by the user in response to a request of the user, and

the controlling means changes a display mode of the transaction object specified by the specifying means to be more conspicuous than a display mode in a case of not being specified by the specifying means.

According to this invention, when transaction objects retrieved under a certain retrieval condition and registered in the reference list are retrieved under another retrieval condition after that, the transaction objects are displayed within the list of retrieval result in the display mode that is more conspicuous than the display mode when the transaction objects have not been registered in the reference list. Therefore, the user can easily notice that the transaction object is present in the list. Thus, it is possible to easily know whether the transaction object of the reference list satisfying a condition in a certain point of view designated by the user satisfies a condition in another point of view designated by the user.

The invention according to claim 3 is the information processing apparatus according to claim 2,

wherein the specifying means further specifies the transaction object associated with the transaction object whose transaction object information is stored in association with a retrieval condition different from the retrieval condition designated by the user in response to the request of the user, and

the controlling means changes a display mode of the transaction object specified by the specifying means to be more conspicuous than a display mode in a case of not being specified by the specifying means.

According to this invention, transaction objects associated with the transaction objects registered in the reference list are displayed within the list in the display mode that is more conspicuous than the display mode when the transaction objects are not the transaction objects associated with the transaction objects registered in the reference list. Since it is highly probable that the user is also interested in the transaction objects associated with the transaction objects in which the user is interested, the user can easily notice that the transaction object highly probable to be interested by the user is included in the list.

The invention according to claim 4 is the information processing apparatus according to claim 2 or 3,

wherein as the number of the transaction objects to be listed is larger, the controlling means increases a changing amount of the display mode of the transaction object specified by the specifying means.

According to this invention, it is possible to prevent the user's interesting transaction object from being buried in a large number of listed transaction objects, so that the user can easily notice the presence of the transaction object.

The invention according to claim 5 is the information processing apparatus according to any one of claims 1 to 4,

wherein the specifying means specifies the transaction objects whose reference list deletion information is stored in the storing means, among the plurality of transaction objects to be listed, and

the controlling means changes the display mode of the transaction object specified by the specifying means to be inconspicuous than the display mode in a case of not being specified by the specifying means.

According to this invention, the transaction objects deleted from the reference list are displayed within the list of retrieval result in the display mode that is more inconspicuous than the display mode when the transaction objects have not been deleted from the reference list. Therefore, since it is unlikely to be noticed that the transaction object in which the user lost interest is present in the list, it is possible to prevent that transaction object from interrupting the browsing of other transaction object.

The invention according to claim 6 is the information processing apparatus according to claim 5, further comprising:

a determining means that determines whether the transaction object has been purchased by the user before the transaction object specified by the specifying means is deleted from the reference list,

wherein when it is determined by the determining means that it has not been purchased, the controlling means increases a more changing amount of the display mode of the transaction object specified by the specifying means than a changing amount when it is determined that it has been purchased.

According to this invention, the transaction objects that have not been purchased before being deleted from the reference list by the user are transaction objects in which the user lost interest more than the purchased transaction objects. Therefore, it is possible to prevent the transaction objects, of which the interest has been further lost, from interrupting the browsing of other transaction objects.

The invention according to claim 7 is an information processing method, which is performed by an information processing apparatus,

the information processing method comprising:

a specifying step of specifying transaction objects whose reference list registration information or reference list deletion information is stored in a storing means that stores at least one of the reference list registration information indicating transaction objects registered by a user in a reference list holding a reference to information on transaction objects and the reference list deletion information indicating transaction objects deleted from the reference list by the user, among a plurality of transaction objects to be listed in response to a request from the user; and

a controlling step of controlling a display mode in the list of the transaction objects specified in the specifying step.

The invention according to claim 8 is an information processing program, which causes a computer included in an information processing apparatus to function as:

a specifying means that specifies transaction objects whose reference list registration information or reference list deletion information is stored in a storing means that stores at least one of the reference list registration information indicating transaction objects registered by a user in a reference list holding a reference to information on transaction objects and the reference list deletion information indicating transaction objects deleted from the reference list by the user, among a plurality of transaction objects to be listed in response to a request from the user; and

a controlling means that controls a display mode in the list of the transaction objects specified by the specifying means.

The invention according to claim 9 is a recording medium recording a computer-readable information processing program thereon, which causes a computer included in an information processing apparatus to function as:

a specifying means that specifies transaction objects whose reference list registration information or reference list deletion information is stored in a storing means that stores at least one of the reference list registration information indicating transaction objects registered by a user in a reference list holding a reference to information on transaction objects and the reference list deletion information indicating transaction objects deleted from the reference list by the user, among a plurality of transaction objects to be listed in response to a request from the user; and

a controlling means that controls a display mode in the list of the transaction objects specified by the specifying means.

### Advantageous Effects of the Invention

According to the present invention, it is highly probable that the transaction objects registered in the reference list are transaction objects in which the user is interested, and it is highly probable that the transaction objects deleted from the reference list are transaction objects in which the user lost interest. Therefore, the list of the plurality of transaction objects can be displayed suitably for the user according to the user's interest.

### BRIEF DESCRIPTION OF THE DRAWINGS

FIG. 1 is a diagram illustrating an example of a schematic configuration of an electronic commerce system S according to an embodiment.

FIG. 2 is a diagram illustrating a screen display example of a retrieval condition page.

FIG. 3A is a diagram illustrating a status when an item is registered to a bookmark, FIG. 3B is a diagram illustrating a status when an item is deleted from a bookmark, and FIG. 3C is a diagram illustrating a display example of a retrieval result page.

FIG. 4 is a block diagram illustrating an example of a schematic configuration of an electronic commerce server 1 according to an embodiment.

FIG. 5A is a diagram illustrating an example of contents registered in a membership information DB 12a, FIG. 5B is a diagram illustrating an example of contents registered in a genre information DB 12b, FIG. 5C is a diagram illustrating an example of contents registered in a shop information DB 12c, FIG. 5D is a diagram illustrating an example of contents registered in an item information DB 12d, FIG. 5E is a diagram illustrating an example of contents registered in a browsing history DB 12e,

FIG. 5F is a diagram illustrating an example of contents registered in a purchase history DB 12f, FIG. 5G is a diagram illustrating an example of contents registered in a bookmark information DB 12g, and FIG. 5H is a diagram illustrating an example of contents registered in a bookmark deletion information DB 12h.

FIG. 6 is a flowchart illustrating a processing example of a retrieval request reception process of a system control unit 14 of the electronic commerce server 1 according to an embodiment.

FIG. 7 is a flowchart illustrating a processing example of a listing score raising control process of the system control unit 14 of the electronic commerce server 1 according to an embodiment.

FIG. 8 is a flowchart illustrating a processing example of a listing score lowering control process of the system control unit 14 of the electronic commerce server 1 according to an embodiment.

FIG. 9A is a flowchart illustrating a processing example of a bookmark registration request reception process of the system control unit 14 of the electronic commerce server 1 according to an embodiment, and FIG. 9B is a flowchart illustrating a processing example of a bookmark deletion request reception process of the system control unit 14 of the electronic commerce server 1 according to an embodiment.

### MODE FOR CARRYING OUT THE INVENTION

Hereinafter, embodiments of the present invention will be described in detail with reference to the drawings. Also, the embodiments described below are embodiments when the present invention is applied to an electronic commerce system.

[1. Overview of Configuration and Function of Electronic Commerce System]

[1-1. Configuration of Electronic Commerce System]

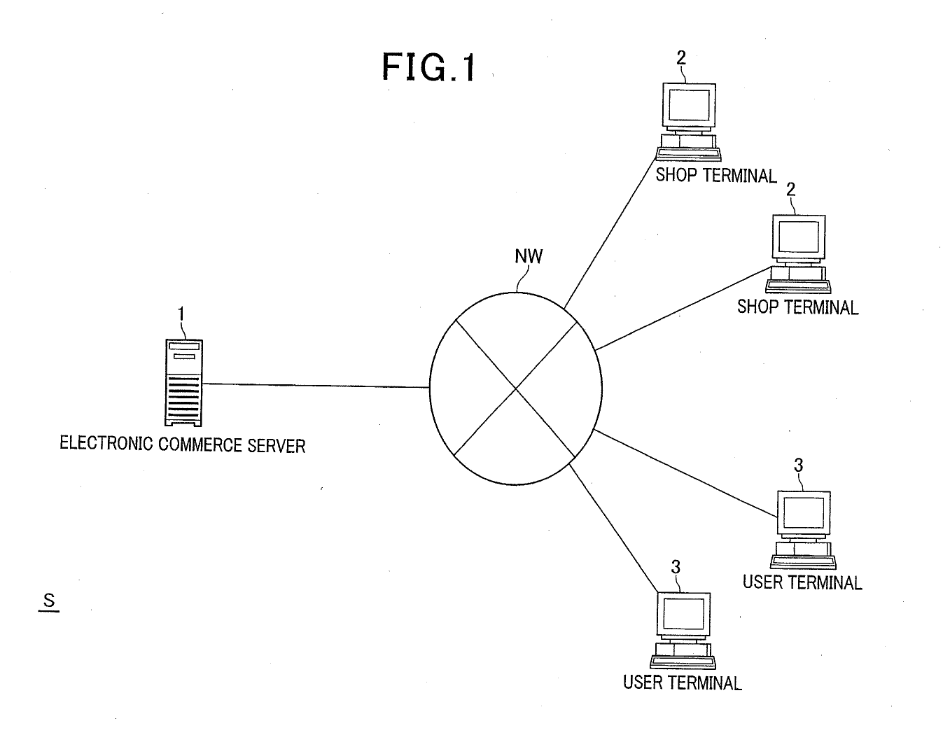

First, the configuration of the electronic commerce system S according to the present embodiment will be described with reference to FIG. 1. FIG. 1 is a diagram illustrating an example of a schematic configuration of an electronic commerce system S according to the present embodiment.

As illustrated in FIG. 1, the electronic commerce system S is configured to include an electronic commerce server 1, a plurality of shop terminals 2, and a plurality of user terminals 3. Moreover, the electronic commerce server 1, and the respective shop terminals 2 and the respective user terminals 3 can mutually transmit and receive data through a network NW by using, for example, TCP/IP or the like as a communication protocol. Also, the network NW is constructed by, for example, Internet, a dedicated communication line (for example, community antenna television (CATV) line), a mobile communication network (including a base station and the like), a gateway, or the like.

The electronic commerce server 1 (an example of an information processing apparatus according to the present invention) is a server apparatus that performs various processes related to an online mall where users can purchase items. Users can purchase desired items from desired shops by using the online mall. The electronic commerce server 1 transmits a web page of an online mall and performs processes associated with retrieving, purchasing, and the like of items, for example, in response to a request from the shop terminal 2 or the user terminal 3.

The shop terminal 2 is a terminal device that is used by an employee or the like of a shop opened in an online mall. The shop terminal 2 is used to, for example, register information on items for sales in the online mall and confirm contents of ordered items. Also, the shop terminal 2 accesses the electronic commerce server 1 based on an operation from an employee or the like, and receives and displays a web page from the electronic commerce server 1. Software such as a browser or an email client is incorporated into the shop terminal 2. As an example of the shop terminal 2, a personal computer or the like is used.

The user terminal 3 is a terminal device of a user who uses the online mall. The user terminal 3 accesses the electronic commerce server 1 based on an operation from the user, and receives and displays a web page from the electronic commerce server 1. Software such as a browser or an email client is incorporated into the user terminal 3. As an example of the user terminal 3, a personal computer, a personal digital assistant (PDA), a mobile information terminal such as a smartphone, a mobile phone, or the like is used.

[1-2. Display of List of Bookmark and Items]

The electronic commerce system S provides a bookmark function. The bookmark function is a function of registering an item sold in an online mall as a bookmark of a user to store a reference to an item page in a user-dedicated list so that the user can easily browse the item page of the bookmarked item. The item page is a web page in which detailed information on one item is displayed. Moreover, the bookmarked item is referred to simply as a bookmark. In an online mall, a hyperlink (hereinafter referred to as a “link”) displayed as “add to bookmark” is displayed in an item page. When a user selects this link, an item of which the information is displayed in the item page is registered in the bookmark of the user. The user can check the items registered in the bookmark in a bookmark page. The bookmark page is a web page in which a list of items registered in the bookmark is displayed and is a dedicated web page of each user. Moreover, a link to an item page of an item registered in the bookmark is embedded in the bookmark page. When the user selects a link to an optional item in the bookmark page, it is possible to display the corresponding item page. Moreover, in the bookmark page, the user can designate an item that does not need to be registered among the items registered in the bookmark of the bookmark page and delete the item from the bookmark.

In the electronic commerce system S, there is a web page on which a list of items being sold in an online mall is displayed. An example of the web page is a retrieval result page. The retrieval result page is a web page that displays a list of items retrieved under a retrieval condition designated by a user. As an example of the retrieval condition, the user can designate a keyword, an item genre, and the like.

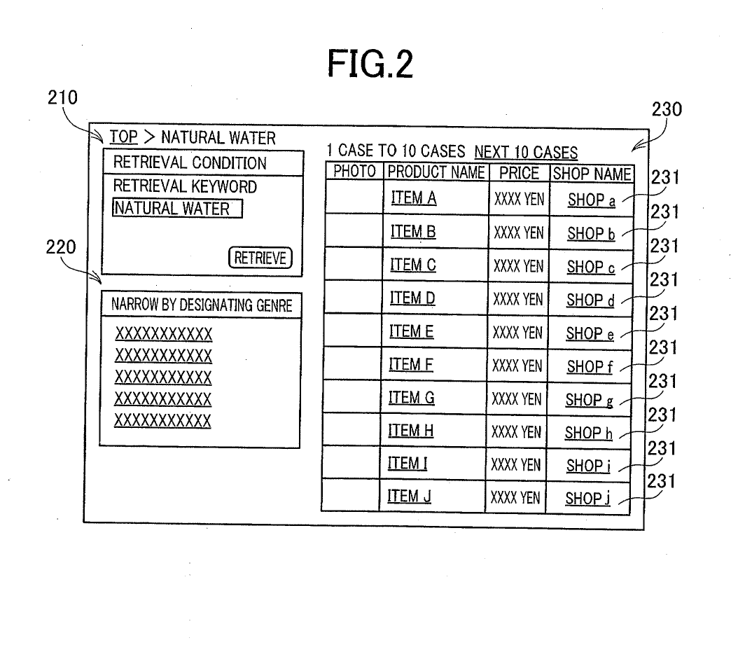

FIG. 2 is a diagram illustrating a screen display example of a retrieval condition page. As illustrated in FIG. 2, the retrieval result page includes a retrieval condition setting region 210, a genre designating region 220, and a retrieval result displaying region 230. The retrieval condition setting region 210 is a region for designating and correcting a keyword as the retrieval condition, or designating a keyword so as to further narrow the retrieved items. The genre designating region 220 is a region for designating a genre as the retrieval condition so as to further narrowing the retrieved items.

A list of information of the retrieved items is displayed in the retrieval result displaying region 230. Specifically, corresponding item information 231 including images, item names, prices, shop names or the like of the retrieved items are displayed in the retrieval result displaying region 230. The corresponding item information 231 is displayed according to display ranking of the retrieved items. Specifically, as the display ranking is higher, the corresponding item information 231 is displayed in an upper portion in the retrieval result displaying region 230. Also, the upper limit of the number of pieces of the corresponding item information 231, which can be displayed in the retrieval result displaying region 230, is determined. For example, when the upper limit is 10, the corresponding item information 231 of the items, of which the display ranking is No. 1 to No. 10, is displayed in the retrieval result displaying region 230. Herein, when a user selects a link displayed as “next 10 cases”, a new retrieval result page is displayed on the screen of the user terminal 3, and the corresponding item information 231 of the items, of which the display ranking is No. 11 to No. 20, is displayed in the retrieval result displaying region 230 of the retrieval result page. The display ranking of the corresponding item information 231 is determined based on a listing score. The listing score is a value indicating an evaluation determined for an item or an item page of the item. A higher listing score indicates a higher evaluation. Thus, as an item has a higher listing score, the display ranking of the corresponding item information 231 of the item is higher. For example, as the number of access (browsing) to the item page is larger, the listing score may be raised. Thus, as the number of purchases of the item is larger, the listing score may be raised. When the user selects certain corresponding item information 231 from the corresponding item information 231 displayed in the retrieval result displaying region 230, an item page of an item corresponding to the selected corresponding item information 231 is displayed. By performing a purchase operation in the item page, the user can purchase an item of which the information is displayed on the item page.

The electronic commerce server 1 controls a display mode of items in the list on the retrieval result page according to the user's interest. Therefore, the electronic commerce server 1 displays the listed items suitably for the user. The user purchases the item in which the user himself or herself is interested. Therefore, if the display mode of each item in the list of items is a display mode corresponding to the user's interest, when the user considers an item to be purchased, it is easy to notice items in which the user is interested, or it is easy to access item pages of purchase candidate items.

Specifically, the electronic commerce server 1 controls the display mode of the listed items, based on the registration status of the items bookmarked by the user. For example, the user's interested item, the purchase candidate item, the user's favorite item, and the like are registered in the bookmark. That is, the items registered in the bookmark are highly probable to be items in which the user is interested.

Therefore, the electronic commerce server 1 changes the display mode of the list of items registered in the bookmark to be more conspicuous than in the case where the items have not been registered in the bookmark. Specifically, the electronic commerce server 1 raises the display ranking of the items registered in the bookmark to be higher than the display ranking in the case where the items have not been registered in the bookmark. That is, the electronic commerce server 1 raises the display ranking of the items registered in the bookmark. However, the electronic commerce server 1 does not always raise the display ranking of the items registered in the bookmark. At the time of retrieval triggered by the registration in the bookmark, the electronic commerce server 1 raises the display ranking of the items of which the retrieval condition designated by the user is different from the retrieval condition designated this time.

The items registered in the bookmark of the user are not necessarily interesting to the user at any time. For example, it is assumed that the user has designated a certain retrieval condition a and registered an item A in the bookmark, the item A being an item interesting among items retrieved under the retrieval condition a. After that, it is assumed that the user has retrieved items by designating the same retrieval condition a again. In this case, it is highly probable that the user knows that the item A is retrieved under the retrieval condition a and the item A is already registered in the bookmark. In this regard, it is difficult to consider that the user is much interested in the item A. For that user, there is no new discovery about the item A. In such a case, when the display ranking of the item A in the list of items is raised, the display ranking of other items is lowered instead. Therefore, there is a case where the confirmation of the information on other items is interrupted.

In this regard, it is assumed that the user has retrieved items by designating a retrieval condition b different from the retrieval condition a. In this case, it is assumed that the item A is included in the retrieved items. When the user finds the item A from the retrieved items, the user newly finds that the item A satisfies the retrieval condition b. A different retrieval condition is to perform a retrieval in a different point of view. That is, the user can find the item A in another point of view. In such a case, it is probable that the user is interested in the item A. Since the item is made conspicuous by raising the display ranking of such items, the user can easily notice that the item is included in the list. That is, the user can easily notice that the interesting item satisfies a condition in another point of view.

Also, there is a case where the user designates a plurality of retrieval conditions. For example, a keyword and a genre are designated, or a plurality of keywords is designated. When a plurality of retrieval conditions is designated, the electronic commerce server 1 may raise the display ranking, for example, when at least one retrieval condition is different. This is because if any one of the retrieval conditions is different, the point of view of retrieval is different. Also, the electronic commerce server 1 may raise the display ranking only when all the retrieval conditions are different.

On the other hand, when the item is deleted from the bookmark, the item is, for example, an item about which the user is not concerned, an item excluded from purchase candidates, or an item the user does not like. That is, the item deleted from the bookmark is highly probable to be an item in which the user lost interest. Also, items excluded from the purchase candidates includes an item unnecessary to purchase because the item has already been purchased. The information of the item in which the user lost interest is information that is unnecessary for the user. If the display ranking is placed in an upper level in the list of items in which the user lost interest, there is a case where the confirmation of information on other items is interrupted due to the presence of the information on the item.

Therefore, in the list of items deleted from the bookmark, the electronic commerce server 1 lowers the display ranking of the item deleted from the bookmark more than the display ranking of the item having not been registered in the bookmark. That is, the display ranking of the item deleted from the bookmark is lowered. Therefore, since the item deleted from the bookmark is unnoticeable, it is difficult to notice that the item in which the user lost interest is included in the list. Therefore, it is possible to prevent the interruption of the confirmation of other items.

Also, the item having not been registered in the bookmark and the item deleted from the bookmark are identical to each other, in that the items are not registered in the current bookmark. However, the item having not been registered in the bookmark is an item having not been deleted from the bookmark. Therefore, it is impossible to know whether the item having not been registered in the bookmark is an item in which the user is interested or an item in which the user is uninterested (including an item in which the user lost interest). Also, there is a case where the item having not been registered in the bookmark is an item the user has not yet known. On the other hand, the item deleted from the bookmark is highly probable to be an item in which the user lost interest. In that respect, the item having not been registered in the bookmark is different from the item deleted from the bookmark.

A specific example will be described below. It is assumed that the retrieval result page illustrated in FIG. 2 is a retrieval result page in the case where a certain user has not registered any one of items to the bookmark. That is, the user has not deleted the item from the bookmark. At this time, corresponding item information 231 on each of ten items from the item A to the item J is displayed in the retrieval result displaying region 230. The display ranking of the item A to the item J is an alphabetical order. That is, the display ranking of the item A is highest. Also, the retrieval result page illustrated in FIG. 2 is a retrieval result page when a keyword “natural water” is designated as the retrieval condition.

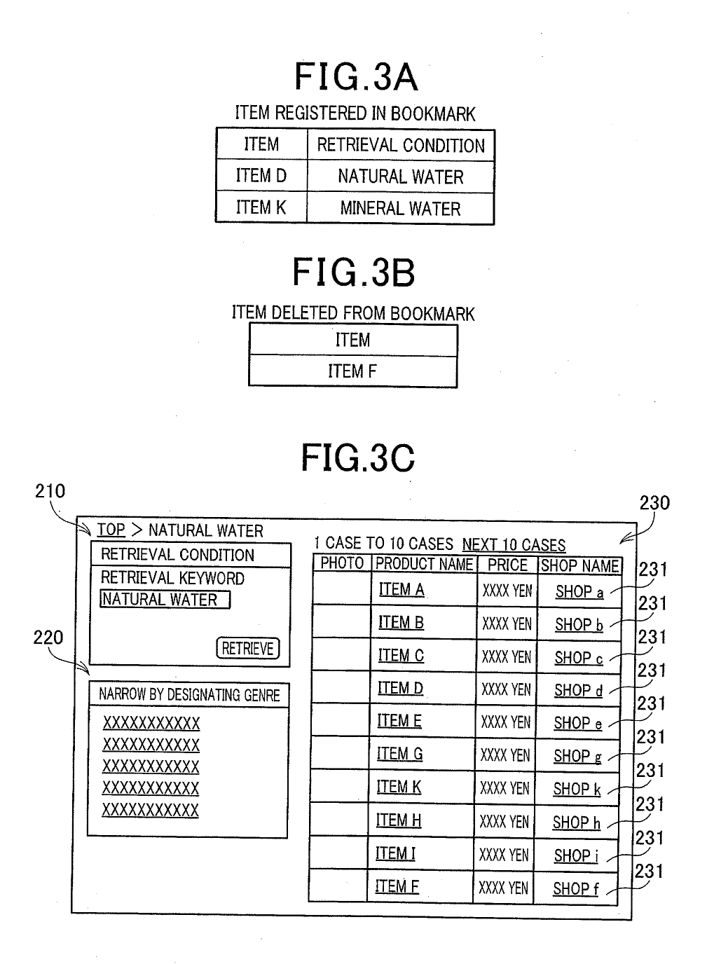

FIG. 3A is a diagram illustrating a status when an item is registered to a bookmark after that. Also, FIG. 3B is a diagram illustrating a status when an item is deleted from a bookmark. Also, FIG. 3C is a diagram illustrating a display example of a retrieval result page.

For example, it is assumed that the user browsed an item page of an item D and an item page of an item F from the retrieval result page illustrated in FIG. 2, and registered the item D and the item F in the bookmark. Then, the user designates a genre of “mineral water” as the retrieval condition, and retrieves items in the electronic commerce server 1. It is assumed that since an item K is included in the items retrieved at that time, the user registered the item K in the bookmark. Actually, the item K is an item retrieved by a keyword “natural water”, but the item K is not displayed on the retrieval result page illustrated in FIG. 2 because the display ranking of the item K is lower than No. 10. After that, it is assumed that the user deleted the item F from the bookmark.

As illustrated in FIG. 3A, the items registered in the current bookmark are the item D and the item K. Also, as illustrated in FIG. 3B, the item deleted from the bookmark is the item F. In this case, the user designates the keyword “natural water” again as the retrieval condition, and retrieves items in the electronic commerce server 1. As illustrated in FIG. 3C, the display ranking of the item D is not changed. This is because the retrieval condition designated when the item D was registered in the bookmark is matched with the retrieval condition designated this time. On the other hand, the display ranking of the item F and the item K is changed. Specifically, the display ranking of the item F is changed from No. 6 to No. 10, and the display ranking of the item K is changed from lower than No. 10 to No. 7.

Also, the electronic commerce server 1 raises the display ranking of the item associated with the item registered in the bookmark. This is because the user may also be interested in the item associated with the item in which the user is interested. Herein, the display ranking of the item associated with that item is raised in the case where the retrieval condition designated by the user upon the retrieval triggered when the item registered in the bookmark is registered in the bookmark is different from the retrieval condition designated this time. Also, the item registered in the bookmark may not be included in the item retrieved in this time. Examples of an item associated with a certain item include an item belonging to the same genre as a certain item, an item of which a shop of a distribution source is the same as a certain item, an option item when a certain item is a main item, and a main item when a certain item is an option item. Examples of the option item include consumables of a replacement brush head or the like with respect to an electric toothbrush being a main item, and accessories of a case accommodating a mobile personal computer with respect to the mobile personal computer being a main item. Information indicating a relation between the main item and the option item may be, for example, stored in the storage unit 12. Also, for example, when an item code of the main item is posted on an item page of the option item or the like, that is, when an item code of the main item is included in item information of the option item or the like, the related item can be specified from the item information.

Also, the electronic commerce server 1 adjusts a raising amount of the display ranking according to the total number of the retrieved items. If the total number of retrieved items is increased, there is a case where even though the display ranking of the item registered in the bookmark is somewhat raised, the retrieved items are buried in a large number of items and thus are relatively inconspicuous. Therefore, the electronic commerce server 1 increases the raising amount of the display ranking as the total number of the retrieved items becomes larger. For example, the electronic commerce server 1 may determines the raising amount of the display ranking by multiplying the total number of the retrieved items by a preset raising amount per item.

Also, in the case of lowering the display ranking of the item deleted from the bookmark, the electronic commerce server 1 changes the lowering amount of the display ranking in the item deleted from the bookmark after being purchased and the item deleted from the bookmark without being purchased. Regarding the item deleted from the bookmark after being purchased, it may be said that the user lost interest in the purchase of that item, but it cannot be definitely said that the user lost interest in that item itself. On the other hand, regarding the item deleted from the bookmark without being purchased, it is highly probable that the user lost interest in the purchase and the item itself. Therefore, the electronic commerce server 1 increases the lowering amount of the display ranking of the item deleted from the bookmark after being purchased more than the lowering amount of the display ranking of the item deleted from the bookmark without being purchased. Also, the electronic commerce server 1 may not lower the display ranking with respect to the item deleted from the bookmark after being purchased.

[2. Configuration of Electronic Commerce Server]

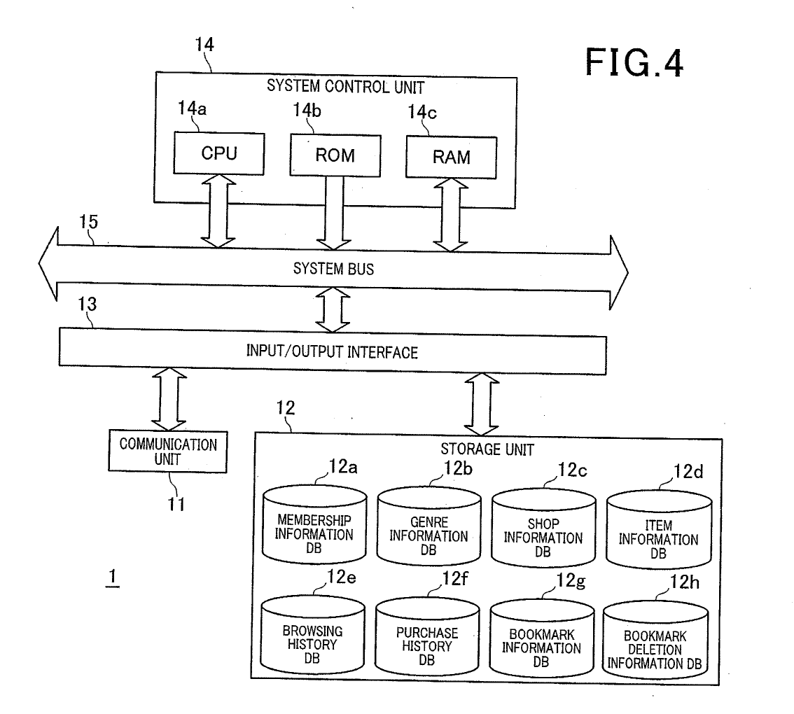

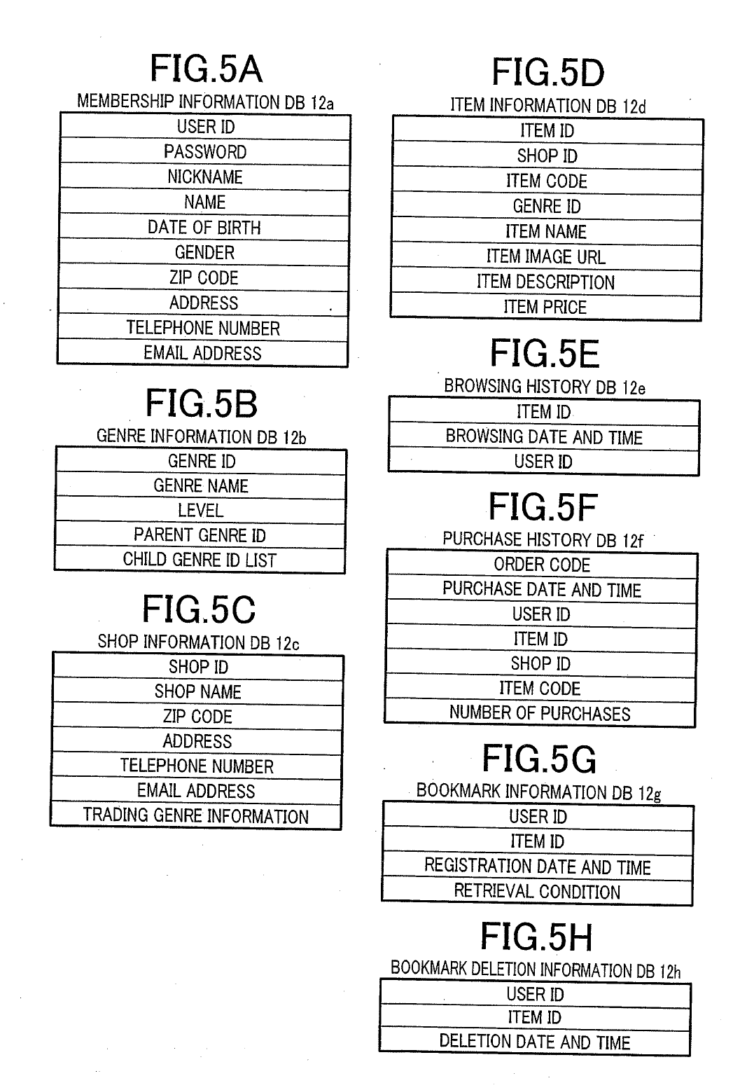

Next, the configuration of the electronic commerce server 1 will be described with reference to FIGS. 4 and 5.

FIG. 4 is a block diagram illustrating an example of a schematic configuration of the electronic commerce server 1 according to the present embodiment. As illustrated in FIG. 4, the electronic commerce server 1 includes a communication unit 11, a storage unit 12, an input/output interface 13, and a system control unit 14. The system control unit 14 and the input/output interface 13 are connected through a system bus 15.

The communication unit 11 is connected to a network NW to control communication states of the shop terminals 2, the user terminals 3, and the like.

The storage unit 12 (an example of a storing means according to the present invention) is configured by, for example, a hard disk drive or the like. Databases such as a membership information DB (database) 12a, a genre information DB 12b, a shop information DB 12c, an item information DB 12d, a browsing history DB 12e, a purchase history DB 12f, a bookmark information DB 12g, a bookmark deletion information DB 12h, and the like are constructed in the storage unit 12.

FIG. 5A is a diagram illustrating an example of contents registered in the member information DB 12a. Membership information of users registered in the electronic commerce system S as members is registered in the membership information DB 12a. Specifically, attributes of a user such as a user ID, a password, a nickname, a name, a date of birth, a gender, a postal code, an address, a telephone number, and an email address are registered in the membership information DB 12a in association with each user. The user ID is identification information of a user.

FIG. 5B is a diagram illustrating an example of contents registered in the genre information DB 12b. Genre information on the genre of an item is registered in the genre information DB 12b. Specifically, attributes of a genre such as a genre ID, a genre name, a genre level, a parent genre ID, and a child genre ID list are registered in the genre information DB 12b in association with each genre. The genre information is set by, for example, an administrator or the like of an online mall. Genres of items are defined hierarchically by a tree structure. Specifically, each node of a tree structure corresponds to a genre. The depth of a node corresponds to the level (class) of the genre corresponding to the node. The depth of a node is a distance from a node (hereinafter referred to as a “root node”) positioned at the root. As the level value is larger, the level depth becomes deeper, and as the level value is smaller, the level depth becomes shallower. A genre corresponding to a child node of the root node is a genre of level 1. The genre of level 1 is the highest genre. A genre corresponding to a child node among the genres of level 1 is defined as a genre of level 2. Herein, a genre C2 corresponding to a child node of a certain genre C1 is referred to as a “child genre” of the genre C1. A child genre is also referred to as a sub-genre. Moreover, the genre C1 at this time is referred to a “parent genre” of the genre C2. The child genre is a range to which the same items belong when the parent genre is further classified into a plurality of genres. Thus, the child genre belongs to a parent genre. The genre ID is identification information of a genre defined by genre information. A parent genre ID is a genre ID of a parent genre of a genre defined by genre information. A child genre ID list is a list of genre IDs of child genres of a genre defined by genre information. The child genre ID list is set when the genre defined by the genre information includes child genres.

FIG. 5C is a diagram illustrating an example of contents registered in the shop information DB 12c. Shop information on a shop that is open at an online mall is registered in the shop information DB 12c. Specifically, attributes of a shop such as a shop ID, a shop name, a zip code, an address, a telephone number, an email address, and trading genre information are registered in the shop information DB 12c in association with each shop. The shop ID is identification information of a shop. The trading genre information is information indicating a genre of items traded by a shop (items sold in a shop). Specifically, a genre ID of each genre of items traded by a shop is set in the trading genre information.

FIG. 5D is a diagram illustrating an example of contents registered in the item information DB 12d. Item information on items sold in an online mall is registered in the item information DB 12d. Specifically, attributes of an item such as an item. ID, a shop ID, an item code, a genre ID, an item name, a uniform resource locator (URL) of an item image, an item description, and an item price are registered in the item information DB 12d in association with each item sold by the shop. The item ID (an example of information indicating the transaction object according to the present invention) is identification information of an item for allowing a shop or the like to manage items to be sold. The shop ID indicates a shop which is a distribution source of an item. The item code is a code number for identifying an item. The item code is, for example, a Japanese article number (JAN) code. The genre ID is an ID of a genre to which an item belongs.

FIG. 5E is a diagram illustrating an example of contents registered in the browsing history DB 12e. A browsing history of an item page of an online mall is registered in the browsing history DB 12e. Specifically, an item ID, a browsing date and time, and a user ID are registered in the browsing history DB 12e in association whenever an item page is browsed. The item ID indicates an item of which the item page is browsed. The browsing date and time indicates the date and time when an item page was browsed. Specifically, the browsing date and time is the date and time when the electronic commerce server 1 transmitted an item page to the user terminal 3. The user ID indicates a user who browsed an item page.

FIG. 5F is a diagram illustrating an example of contents registered in the purchase history DB 12f. A purchase history of items purchased by a user is registered in the purchase history DB 12f. Specifically, an order code, a purchase date and time, a user ID, an item ID, a shop ID, an item code, the number of purchases, and the like are registered in the purchase history DB 12f in association with each purchase of items. The order code is identification information of an order assigned whenever an item is ordered. The user ID indicates a user who purchased an item. The item ID and the item code indicate an item which has been purchased. The shop ID indicates a shop which is a purchase destination. The number of purchases is the number of items which has been purchased.

FIG. 5G is a diagram illustrating an example of contents registered in the bookmark information DB 12g. Bookmark information (an example of reference list information according to the present invention) on the bookmark of a user is registered in the bookmark information DB 12g. Specifically, a user ID, an item ID, a registration date and time, and the like are registered in the bookmark information DB 12g in association whenever an item is registered in a bookmark. The user ID indicates a user who has registered an item in a bookmark. The item ID indicates an item registered in a bookmark. Moreover, the item ID is information corresponding to a reference to an item page of the item registered in the bookmark. Although the information of an actual reference to the item page is a URL, the URL of the item page can be specified from the item ID. The URL of the item page may be registered in the bookmark information DB 12g together with the item ID or in place of the item ID. The registration date and time indicates the date and time when an item was registered in the bookmark. The retrieval condition is a condition designated by the user so as to retrieve the items registered in the bookmark.

FIG. 5H is a diagram illustrating an example of contents registered in the bookmark deletion information DB 12h. Bookmark deletion information associated with an item deleted from a bookmark is registered in the bookmark deletion information DB 12h. Specifically, a user ID, an item ID, a deletion date and time, and the like are registered in the bookmark deletion information DB 12h in association whenever an item is deleted from a bookmark. The user ID indicates a user who has deleted an item from a bookmark. The item ID indicates an item deleted from a bookmark. The deletion date and time indicates the date and time when an item was deleted from the bookmark.

Next, other pieces of information stored in the storage unit 12 will be described. Various types of data such as a hypertext markup language (HTML) document, an extensible markup language (XML) document, image data, text data, and an electronic document for displaying a web page are stored in the storage unit 12. Moreover, various setting values set by an administrator or the like are stored in the storage unit 12.

Moreover, various programs such as an operating system, a world wide web (WWW) server program, a database management system (DBMS), an electronic commerce management program, an item evaluation program are stored in the storage unit 12. The electronic commerce management program is a program for executing various processes associated with electronic commerce. The item evaluation program is a program for determining a listing score of each item. The listing score of each item is frequently updated by the item evaluation program and, for example, the listing score is stored in the storage unit 12 in association with the item ID. The system control unit 14 can acquire the listing score from the item evaluation program, for example, through a dedicated application programming interface (API). The various programs may be acquired from another server apparatus through the network NW or may be recorded in a recording medium such as a digital versatile disc (DVD) and read by a drive device.

The input/output interface 13 is configured to perform interfacing processes between the communication unit 11 and the storage unit 12, and the system control unit 14.

The system control unit 14 is configured to include a CPU 14a, a read only memory (ROM) 14b, and a random access memory (RAM) 14c. The system control unit 14 is configured to function as a specifying means, a controlling means, and a determining means of the present invention when the CPU 14a reads and executes various programs.

Also, the electronic commerce server 1 may be configured as a plurality of server apparatuses. For example, a server apparatus that performs processes associated with a bookmark, a server apparatus that performs processes associated with retrieving, ordering, and the like of items in an online mall, a server apparatus that transmits a web page in response to a request from the user terminal 3, a server apparatus that manages databases, and the like may be connected to each other by a LAN or the like.

[3. Operation of Electronic Commerce System]

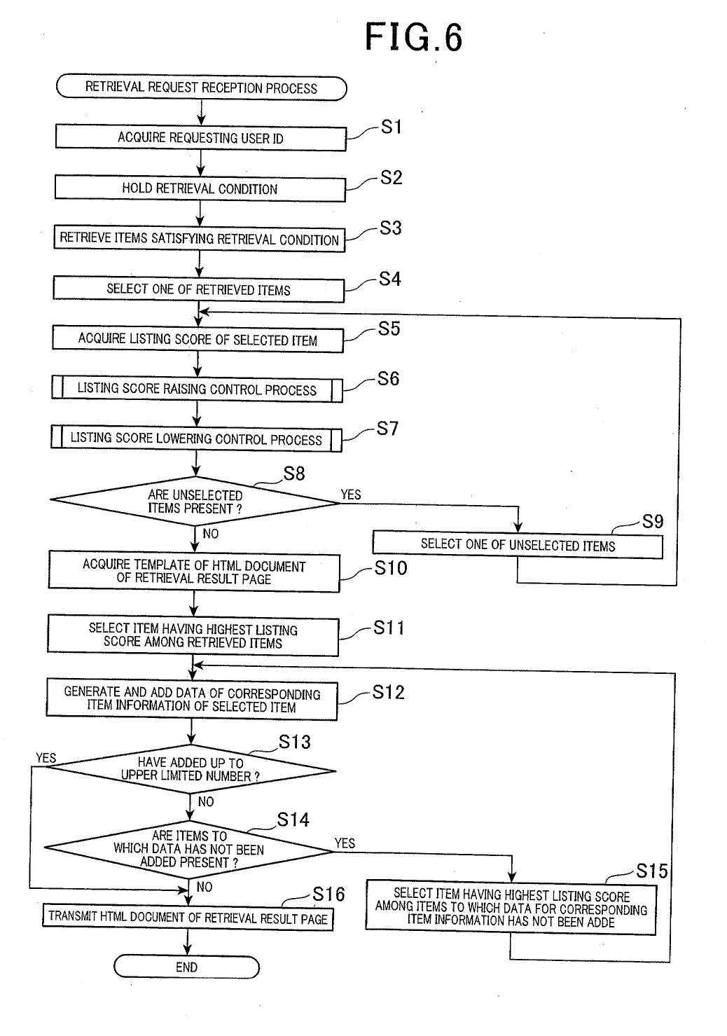

Next, the operation of the electronic commerce system S will be described with reference to FIGS. 6 to 9.

[3-1-1. Item Retrieval Operation]

FIG. 6 is a flowchart illustrating a processing example of a retrieval request reception process of the system control unit 14 of the electronic commerce server 1 according to the present embodiment.

For example, it is assumed that a user logs in to the electronic commerce system S in advance. The system control unit 14 receives a user ID from the user terminal 3 upon the login of the user, and stores the received user ID in the user terminal 3 as a cookie. Therefore, when the user logs in, the cookie including the user ID is added to a request that is to be transmitted from the user terminal 3 to the electronic commerce server 1. Also, the user ID included in the cookie added to the request the electronic commerce server 1 receives is referred to as “requesting user ID”. Also, the user indicated by the requesting user ID is referred to as “requesting user”.

The user designates a retrieval condition for retrieving items in a web page of an online mall. Then, the user terminal 3 transmits the retrieval request including the designated retrieval condition to the electronic commerce server 1. The retrieval request reception process is started when the electronic commerce server 1 receives the retrieval request from the user terminal 3.

First, the system control unit 14 acquires the requesting user ID from the received retrieval request (step S1). Subsequently, the system control unit 14 holds the retrieval condition, which is set to the received retrieval request, in association with the requesting user ID (step S2). Herein, the held retrieval condition is associated with an item registered in the bookmark among items retrieved under the retrieval condition when a registration to the bookmark is performed.

Subsequently, the system control unit 14 retrieves items satisfying the retrieval condition (step S3). Specifically, when a keyword is set as the retrieval condition, the system control unit 14 retrieves items that include the keyword in at least one of an item name and an item description. Also, when an genre ID is set as the retrieval condition, the system control unit 14 retrieves items that belong to a genre corresponding to the genre ID. When a plurality of retrieval conditions is set, the system control unit 14 retrieves items that satisfy the plurality of retrieval conditions. Also, for example, the system control unit 14 may perform the item retrieval in an information processing apparatus, such as a server apparatus, other than the electronic commerce server 1, and acquire retrieval result information (for example, a list of item IDs of the retrieved items) from the information processing apparatus. At this time, the system control unit 14 may acquire the retrieval result information, together with the listing scores of the retrieved items, from the information processing apparatus. Also, for example, the system control unit 14 may retrieve items by calling a program including an item evaluation program as a program for retrieving items. Thus, the system control unit 14 may acquire the retrieval result information, together with the listing scores of the retrieved items, for example, through an API.

Subsequently, the system control unit 14 selects one of the retrieved items as a selected item (step S4). Subsequently, the systemcontrol unit 14 acquires a listing score of the selected item, for example, through the API of the item evaluation program (step S5). Subsequently, the system control unit 14 performs a listing score raising control process to be described below (step S6). Subsequently, the system control unit 14 performs a listing score lowering control process to be described below (step S7). In the listing score raising control process, when the selected item is an item satisfying a condition that raises the listing score, the listing score of the selected item is raised. Also, in the listing score lowering control process, when the selected item is an item satisfying a condition that lowers the listing score, the listing score of the selected item is lowered. If the listing score is raised or lowered, the display ranking of the selected item is raised or lowered.

Subsequently, the system control unit 14 determines whether unselected items are present in the retrieved items (step S8). At this time, when it is determined that the unselected items are present (YES in the step S8), the system control unit 14 selects one of the unselected items (step S9). Subsequently, the system control unit 14 proceeds to step S5. The system control unit 14 may raise or lower the listing score of each of the retrieved items, if necessary, by repeating the processes of the steps S5 to S9.

Then, when it is determined that all the items have been selected (NO in the step S8), the system control unit 14 acquires a template of an HTML document of the retrieval result page from the storage unit 12 (step S10). Subsequently, the system control unit 14 selects, as an selected item, one of the retrieved items which has the highest listing score after the listing score raising control process and the listing score lowering control process (step S11). Subsequently, the system control unit 14 generates data for corresponding item information 231, based on item information of the selected item. Then, the system control unit 14 additionally sets the generated data to a region corresponding to a retrieval result displaying region 230 in the acquired template (step S12).

Subsequently, the system control unit 14 determines whether the data for the corresponding item information 231 has been added up to an upper limit capable of displaying the corresponding item information 231 (step S13). At this time, when it is determined as added up to the upper limit (YES in the step S13), the system control unit 14 proceeds to step S16. On the other hand, when it is determined as not added up to the upper limit (NO in the step S13), the system control unit 14 determines whether items to which the data for the corresponding item information 231 has not yet been added are present among the retrieved items (step S14). At this time, when it is determined that the items to which the data for the corresponding item information 231 has not been added are present (YES in the step S14), the system control unit 14 selects one item that has the highest listing score among the items to which the data for the corresponding item information 231 has not been added (step S15). Subsequently, the system control unit 14 proceeds to step S12. The system control unit 14 repeats the processes of the steps S12 to S15 so that the corresponding item information 231 of the item is preferentially displayed as the listing score of the item is higher. On the other hand, when it is determined that the data for the corresponding item information 231 has been added to all the items (NO in the step S14), the system control unit 14 proceeds to step S16.

In step S16, the system control unit 14 transmits the HTML document of the retrieval result page, which has been completed by the setting of the data for the corresponding item information 231, to the user terminal 3 of the retrieval request transmission source (step S16). When this processing is completed, the system control unit 14 ends the retrieval request reception process. The user terminal 3 having received the HTML document of the retrieval result page from the electronic commerce server 1 displays the retrieval result page on a screen, based on the HTML document. At this time, the user terminal 3 displays the corresponding item information 231 from an upper portion of the retrieval result displaying region 230 in setting order of the data, based on the data for the corresponding item information 231.

Also, the system control unit 14 may directly change the display ranking of the item, instead of indirectly changing the display ranking of the item by changing the listing score. For example, the system control unit 14 determines the tentative display ranking of each of the retrieved items, based on the listing score of each of the items which is acquired through the API of the item evaluation program. Subsequently, the system control unit 14 determines whether each of the retrieved items is an item satisfying a condition that raises the display ranking or an item satisfying a condition that lowers the display ranking. The determining method is similar to a determining method in a listing score raising control process and a listing score lowering control process, which are to be described below. The system control unit 14 raises the display ranking of the item from a tentative display ranking when the item satisfies the condition that raises the display ranking, and lowers the display ranking of the item from a tentative display ranking when the item satisfies the condition that lowers the display ranking. Also, the system control unit 14 changes the display ranking of other items from the tentative display ranking, if necessary, according to the raising or lowering of the display ranking. In this manner, the system control unit 14 determines a final display ranking of each of the retrieved items. Then, the system control unit 14 generates an HTML document of the retrieval result page, based on the final display ranking. That is, the system control unit 14 adds the data for the corresponding item information 231 to a template of the HTML document of the retrieval result page in descending order of the final display ranking of the items.

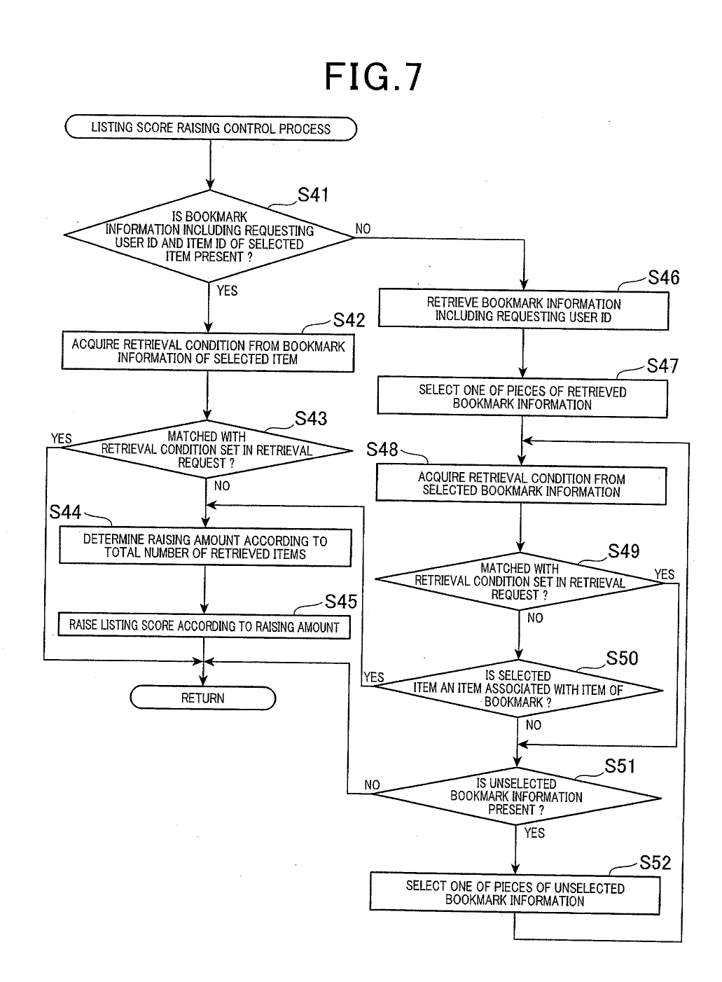

FIG. 7 is a flowchart illustrating a processing example of a listing score raising control process of the system control unit 14 of the electronic commerce server 1 according to the present embodiment.

As illustrated in FIG. 7, the system control unit 14 determines whether bookmark information including the requesting user ID and the item ID of the selected item has been registered in the bookmark information DB 12g (step S41). That is, the system control unit 14 determines whether the selected item has been registered in the bookmark of the requesting user. At this time, when it is determined that the bookmark information has been registered (YES in the step S41), the system control unit 14 acquires a retrieval condition from the bookmark information including the requesting user ID and the item ID of the selected item (step S42). Subsequently, the system control unit 14 determines whether the acquired retrieval condition is matched with the retrieval condition set in the retrieval request (step S43). In this case, when it is determined as matched (YES in the step S43), the system control unit 14 ends the listing score raising control process. That is, the system control unit 14 does not raise the listing score of the selected item.

On the other hand, when it is determined as not matched (NO in the step S43), the system control unit 14 determines the raising amount of the listing score according to the total number of the retrieved items (step S44). Specifically, the system control unit 14 increases the raising amount as the total number of the retrieved items becomes larger. Subsequently, the system control unit 14 raises the listing score of the selected item according to the determined raising amount (step S45). For example, the system control unit 14 may add the determined raising amount to the listing score of the selected item, or may multiply the determined raising amount by the listing score of the selected item. When this processing is completed, the system control unit 14 ends the listing score raising control process.

Therefore, the system control unit 14 specifies the item registered in the bookmark information in association with the retrieval condition different from the retrieval condition designated this time, from the items of which the bookmark information of the requesting user has been registered among the items retrieved based on the retrieval condition registered this time by the user, as a specifying means, by the processes of the steps S41 to S43. Then, the system control unit 14 raises the display ranking of the specified item to be higher than that in the case where the bookmark information of that item has not been registered, by raising the listing score of the specified item, as a controlling means, by the process of the step S45.

In step S41, when it is determined that the bookmark information including the requesting user ID and the item ID of the selected item has not been registered (NO in the step S41), the system control unit 14 retrieves the bookmark information including the requesting user ID from the bookmark information DB 12g (step S46). That is, the system control unit 14 retrieves the items registered in the bookmark of the requesting user. Subsequently, the system control unit 14 selects one of pieces of the retrieved bookmark information (step S47).

Subsequently, the system control unit 14 acquires a retrieval condition from the selected bookmark information (step S48). Subsequently, the system control unit 14 determines whether the acquired retrieval condition is matched with the retrieval condition set in the retrieval request (step S49). At this time, when it is determined as matched (YES in the step S49), the system control unit 14 proceeds to step S51. On the other hand, when it is determined as not matched (NO in the step S49), the system control unit 14 determines whether the selected item is an item associated with the item indicated by the item ID set in the selected bookmark information (step S50). For example, the system control unit 14 determines whether the selected item is an item belonging to the same genre as that of the item indicated by the item ID set in the selected bookmark information, based on the genre ID set in the item information. Also, for example, the system control unit 14 determines whether the selected item is an item of which a shop of a distribution source is identical to that of the item indicated by the item ID set in the selected bookmark information, based on the shop ID set in the item information. At this time, when it is determined that the selected item is the item associated with the item indicated by the item ID set in the selected bookmark information (YES in the step S50), the system control unit 14 proceeds to step S44.

On the other hand, when it is determined that the selected item is not the item associated with the item indicated by the item ID set in the selected bookmark information (NO in the step S50), the system control unit 14 determines whether unselected bookmark information is present in the retrieved bookmark information (step S51). In this case, when it is determined that the unselected bookmark information is present (YES in the step S51), the system control unit 14 selects one of pieces of the unselected bookmark information (step S52). Subsequently, the system control unit 14 proceeds to step S48. On the other hand, when it is determined that all pieces of the bookmark information have been selected (NO in the step S51), the system control unit 14 ends the listing score raising control process.

In this manner, the system control unit 14 specifies the item associated with the item of which the bookmark information including the retrieval condition different from the retrieval condition designated this time by the user is registered in the bookmark information DB 12g, as a specifying means, by repeating the processes of the steps S48 to S52. Then, the system control unit 14 raises the display ranking of the specified item.

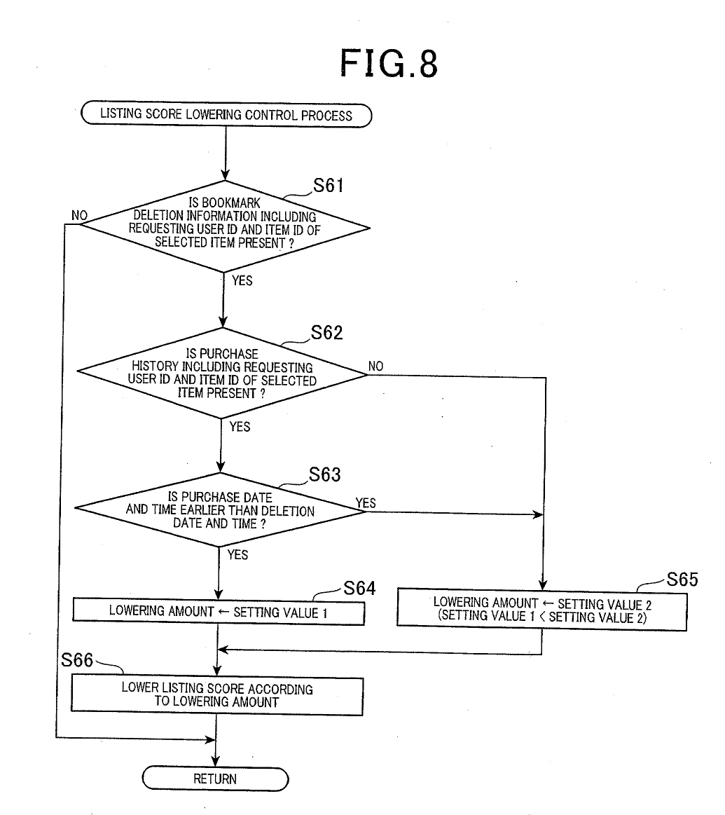

FIG. 8 is a flowchart illustrating a processing example of a listing score lowering control process of the system control unit 14 of the electronic commerce server 1 according to the present embodiment.

As illustrated in FIG. 8, the system control unit 14 determines whether bookmark deletion information including the requesting user ID and the item ID of the selected item has been registered in the bookmark deletion information DB 12h (step S61). That is, the system control unit 14 determines whether the selected item has been deleted from the bookmark of the requesting user. At this time, when it is determined that the bookmark deletion information has not been registered (NO in the step S61), the system control unit 14 ends the listing score lowering control process. That is, the system control unit 14 does not lower the listing score of the selected item.

On the other hand, when it is determined that the bookmark deletion information has been registered (YES in the step S61), the system control unit 14 determines whether a purchase history including the requesting user ID and the item ID of the selected item has been registered in the purchase history DB 12f (step S62). That is, the system control unit 14 determines whether the requesting user has purchased the selected item. At this time, when it is determined that the purchase history has been registered (YES in the step S62), the system control unit 14 determines whether a purchase date and time set in the purchase history is earlier than a deletion date and time set in the bookmark deletion information (step S63). At this time, when it is determined that the purchase date and time is earlier than the deletion date and time (YES in the step S63), the system control unit 14 sets a setting value 1 stored in the storage unit 12 as the lowering amount (step S64).

On the other hand, when it is determined that the purchase history has not been registered (NO in the step S62), or when it is determined that the purchase date and time is not earlier than the deletion date and time (NO in the step S63), the system control unit 14 sets a setting value 2 stored in the storage unit 12 as the lowering amount (step S65). The setting value 2 is greater than the setting value 1. Also, the setting value 1 may be zero. That is, the system control unit 14 may not lower the listing score with respect to the items purchased before being deleted from the bookmark.

When the lowering amount is set in the step S64 or S65, the system control unit 14 lowers the listing score of the selected item according to the set lowering amount (step S66). For example, the system control unit 14 may subtract the set lowering amount from the listing score of the selected item, or may divide the set lowering amount by the listing score of the selected item. When this processing is completed, the system control unit 14 ends the listing score lowering control process.

In this manner, the system control unit 14 specifies the item of which the bookmark deletion information has been registered, by the process of the step S61. Then, the system control unit 14 lowers the display ranking of the specified item to be lower than that in the case where the bookmark deletion information of that item has not been registered, by lowering the listing score of the specified item, as a controlling means, by the process of the step S66.

[3-1-2. Operation of Registering Item to Bookmark]

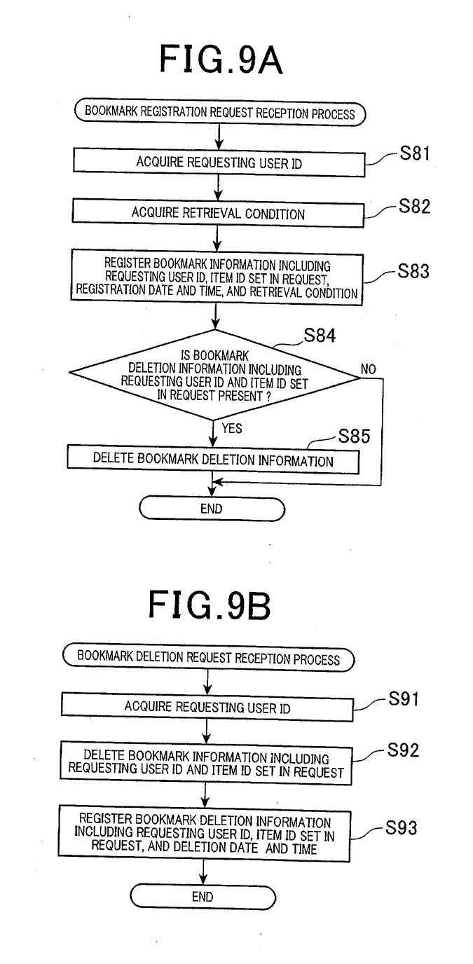

FIG. 9A is a flowchart illustrating a processing example of a bookmark registration request reception process of the system control unit 14 of the electronic commerce server 1 according to the present embodiment.

When the user selects a certain item from the retrieval result page displayed by the user terminal 3, the user terminal 3 transmits a request for an item page of the selected item to the electronic commerce server 1, and the electronic commerce server 1 transmits the corresponding item page to the user terminal 3. When the user selects a link displayed as “add to bookmark” on the item page displayed by the user terminal 3, the user terminal 3 transmits a bookmark registration request to the electronic commerce server 1. In the bookmark registration request, an item ID of an item to be registered to the bookmark is set. The bookmark registration request reception process is started when the electronic commerce server 1 receives the bookmark registration request from the user terminal 3.

First, the system control unit 14 acquires the requesting user ID from the received bookmark registration request (step S81). Subsequently, the system control unit 14 acquires the retrieval condition held in association with the requesting user ID (step S82). Subsequently, the system control unit 14 acquires the current date and time as registration date and time. Then, the system control unit 14 registers the requesting user ID, the item ID set in the bookmark registration request, the registration date and time, and the retrieval condition to the bookmark information DB 12g in association with each other (step S83).

Subsequently, the system control unit 14 determines whether the bookmark deletion information including the requesting user ID and the item ID set in the bookmark registration request has been registered in the bookmark deletion information DB 12h (step S84). At this time, when it is determined as not registered (NO in the step S84), the system control unit 14 ends the bookmark registration request reception process. On the other hand, when it is determined as registered (YES in the step S84), the system control unit 14 deletes the bookmark deletion information including the requesting user ID and the item ID set in the bookmark registration request from the bookmark deletion information DB 12h (step S85). This process is performed when the user registers the items, which have been deleted from the bookmark, again in the bookmark. It is considered that such items are items in which the user lost interest but is interested again after that. When this processing is completed, the system control unit 14 ends the bookmark registration request reception process.

[3-1-3. Operation of Deleting Item from Bookmark]

FIG. 9B is a flowchart illustrating a processing example of a bookmark deletion request reception process of the system control unit 14 of the electronic commerce server 1 according to the present embodiment.

On the bookmark page, the user selects a certain item of the items registered in the bookmark as an item to be deleted from the bookmark, and selects a button displayed as “delete”. Then, the user terminal 3 transmits the bookmark deletion request, which includes the item ID of the selected item, to the electronic commerce server 1. The bookmark deletion request reception process is started when the electronic commerce server 1 receives the bookmark deletion request from the user terminal 3.

First, the system control unit 14 acquires the requesting user ID from the received bookmark deletion request (step S91). Subsequently, the system control unit 14 deletes the bookmark information, which includes the requesting user ID and the item ID set in the request, from the bookmark information DB 12g (step S92). Subsequently, the system control unit 14 acquires the current date and time as deletion date and time. Subsequently, the system control unit 14 registers the requesting user ID, the item ID set in the request, and the deletion date and time in the bookmark deletion information DB 12h in association with each other (step S93). When this processing is completed, the system control unit 14 ends the bookmark deletion request reception process.

As described above, according to the present embodiment, the system control unit 14 of the electronic commerce server 1 specifies an item of which the bookmark information has been registered in the bookmark information DB 12g or an item of which the bookmark deletion information has been registered in the bookmark deletion information DB 12h, among the plurality of items to be listed in response to the request from the user terminal 3, and controls the display mode for displaying the list of the plurality of items. Therefore, the list of the plurality of items can be displayed suitably for the user according to the user's interest.

Also, the system control unit 14 specifies an item of which the item ID has been registered in the bookmark information DB 12g in association with the retrieval condition different from that retrieval condition, from the items of which the bookmark information has been registered in the bookmark information DB 12g among the items retrieved based on the retrieval condition designated by the user in response to the retrieval request from the user terminal 3, and changes the display mode of the specified item to be more conspicuous than the display mode in the case of not being specified. Therefore, the user can easily notice that the item is present in the list. Thus, it is possible to easily know whether the bookmarked item satisfying a condition in a point of view designated by the user satisfies a condition in another point of view designated by the user.

Also, the system control unit 14 further specifies items associated with the item of which item ID has been registered in the bookmark information DB 12g in association with the retrieval condition different from the retrieval condition designated by the user in response to the retrieval request from the user terminal 3, and changes the display mode of the specified item to be more conspicuous than the display mode in the case of not being specified. Therefore, since it is highly probable that the user is also interested in the items associated with the item in which the user is interested, the user can easily notice that the item highly probable to be interested by the user is included in the list.

Also, the system control unit 14 increases the changing amount of the display mode of the specified item as the total number of the retrieved items is larger. Therefore, it is possible to prevent the user's interesting item from being buried in a large number of listed items, so that the user can easily notice the presence of the item.

Also, the system control unit 14 specifies the item of which the bookmark deletion information has been registered in the bookmark deletion information DB 12h, and changes the display mode of the specified item to be more inconspicuous than the display mode in the case of not being specified. Therefore, since it is unlikely to be noticed that the item in which the user lost interest is present in the list, it is possible to prevent that item from interrupting the browsing of other items.

Also, the system control unit 14 determines whether the item specified as the item deleted from the bookmark has been purchased by the user before being deleted from the bookmark. When it is determined as not purchased, the system control unit 14 increases the changing amount of the display mode of the specified item more than that when it is determined as purchased. Therefore, it is possible to prevent the item in which the user lost interest from interrupting the browsing of other items.

Also, according to the above embodiment, the present invention has been applied to the case of displaying the list of items retrieved based on the retrieval condition designated by the user. However, the present invention can be applied to the displaying of the list of any items. For example, the present invention may be applied to the displaying of the list of items treated as specials. Information indicating the items treated as specials is stored in the storage unit 12, for example, as the list of item IDs. When it is determined that the list of items treated as specials is requested by the user, based on the request from the user terminal 3, the electronic commerce server 1 specifies the items to be listed, based on the list stored in the storage unit 12. Also, the retrieval condition has not been designated from the user in the list of such items. Thus, when the item registered in the bookmark is present in the items to be listed, the electronic commerce server 1 may raise the display ranking of that item.

Also, according to the above embodiment, the electronic commerce server 1 has indirectly controlled the display ranking of the item in the list by lowering or raising the listing score. However, the electronic commerce server 1 may directly control the display ranking. Also, the display ranking of each item in the list of items may be, for example, a preset order, instead of descending order of listing scores. In this case, the electronic commerce server 1 directly controls the display ranking.

Also, according to the above embodiment, the electronic commerce server 1 has controlled the display ranking as the display mode of listed items. However, the electronic commerce server 1 may control, for example, the size of the corresponding item information 231, the size or thickness of character in the corresponding item information 231, and color or transparency of character in the corresponding item information 231 as the display mode, so that the display mode is changed to a conspicuous display mode or a inconspicuous display mode.

Also, the electronic commerce server 1 may perform only one of the changing of the display mode of the listed items to the conspicuous display mode based on the bookmark information and the changing of the display mode of the listed items to the inconspicuous display mode based on the bookmark deletion information.

Also, according to the above embodiment, the electronic commerce server 1 has controlled the display mode of the item based on only the bookmark information and the bookmark deletion information of the user of the user terminal 3 transmitting the request. However, the electronic commerce server 1 may control the display mode of the item, for example, based on bookmark information and bookmark deletion information of other user associated with that user. For example, there is provided a function of registering users of the electronic commerce system S as their own friends. For example, the user can browse the items of the bookmark of other user registered as his or her own friends. For example, a friend information DB in which a user ID of a user registered as that user's friend is registered in association with the user ID of the user is constructed in the storage unit 12 of the electronic commerce server 1. In the listing score raising control process or the listing score lowering control process, the electronic commerce server 1 specifies the user's friend based on the friend information DB, and controls the display ranking of the item based on the bookmark information and the bookmark deletion information of the friend. Also, the method of controlling the display ranking based on the bookmark information and the bookmark deletion information of the friend is similar to the method of controlling the display ranking based on the bookmark information and the bookmark deletion information of the user himself or herself.

Also, in the above embodiment, the transaction object according to the present invention has been applied to the item. However, the transaction objects may be applied to services. Thus, the present invention may be applied to a system capable of service reservation as the electronic commerce system. Examples of the service reservation include an accommodation reservation of an accommodation facility, a use reservation of an athletic facility such as a golf course, and a seat reservation of a transport facility.

### REFERENCE SIGN LIST

1 electronic commerce server
2 shop terminal
3 user terminal
11 communication unit
12 storage unit
12a membership information DB
12b genre information DB
12c shop information DB
12d item information DB
12e browsing history DB
12f purchase history DB
12g bookmark information DB
12g bookmark deletion information DB
13 input/output interface
14 system control unit
14a CPU
14b ROM
14c RAM
15 system bus
NW network
S electronic commerce system

1-9. (canceled)

10. An information processing apparatus comprising:
a specifying means that specifies transaction objects whose reference list registration information or reference list deletion information is stored in a storing means that stores at least one of the reference list registration information indicating transaction objects registered by a user in a reference list holding a reference to information on transaction objects and the reference list deletion information indicating transaction objects deleted from the reference list by the user, among a plurality of transaction objects to be listed in response to a request from the user; and
a controlling means that controls a display mode in the list of the transaction objects specified by the specifying means.

11. The information processing apparatus according to claim 10,
wherein the storing means stores transaction object information indicating transaction objects registered in the reference list of the user as the reference list registration information among a plurality of transaction objects retrieved based on a retrieval condition designated by the user, and the retrieval condition in association with each other,
the specifying means specifies transaction objects whose transaction object information is stored in association with a retrieval condition different from the corresponding retrieval condition, from transaction objects whose reference list registration information is stored in the storing means among transaction objects retrieved based on the retrieval condition designated by the user in response to a request of the user, and
the controlling means changes a display mode of the transaction object specified by the specifying means to be more conspicuous than a display mode in a case of not being specified by the specifying means.

12. The information processing apparatus according to claim 11,
wherein the specifying means further specifies the transaction object associated with the transaction object whose transaction object information is stored in association with a retrieval condition different from the retrieval condition designated by the user in response to the request of the user, and
the controlling means changes a display mode of the transaction object specified by the specifying means to be more conspicuous than a display mode in a case of not being specified by the specifying means.

13. The information processing apparatus according to claim 11,
wherein as the number of the transaction objects to be listed is larger, the controlling means increases a changing amount of the display mode of the transaction object specified by the specifying means.

14. The information processing apparatus according to claim 10,
wherein the specifying means specifies the transaction objects whose reference list deletion information is stored in the storing means, among the plurality of transaction objects to be listed, and
the controlling means changes the display mode of the transaction object specified by the specifying means to be inconspicuous than the display mode in a case of not being specified by the specifying means.

15. The information processing apparatus according to claim 14, further comprising:
a determining means that determines whether the transaction object has been purchased by the user before the transaction object specified by the specifying means is deleted from the reference list,
wherein when it is determined by the determining means that it has not been purchased, the controlling means increases a more changing amount of the display mode of the transaction object specified by the specifying means than a changing amount when it is determined that it has been purchased.

16. An information processing method, which is performed by an information processing apparatus,
the information processing method comprising:
a specifying step of specifying transaction objects whose reference list registration information or reference list deletion information is stored in a storing means that stores at least one of the reference list registration information indicating transaction objects registered by a user in a reference list holding a reference to information on transaction objects and the reference list deletion information indicating transaction objects deleted from the reference list by the user, among a plurality of transaction objects to be listed in response to a request from the user; and
a controlling step of controlling a display mode in the list of the transaction objects specified in the specifying step.

17. The information processing apparatus according to claim 12,
wherein as the number of the transaction objects to be listed is larger, the controlling means increases a changing amount of the display mode of the transaction object specified by the specifying means.

18. The information processing apparatus according to claim 11,
wherein the specifying means specifies the transaction objects whose reference list deletion information is stored in the storing means, among the plurality of transaction objects to be listed, and
the controlling means changes the display mode of the transaction object specified by the specifying means to be inconspicuous than the display mode in a case of not being specified by the specifying means.

19. The information processing apparatus according to claim 12,
wherein the specifying means specifies the transaction objects whose reference list deletion information is stored in the storing means, among the plurality of transaction objects to be listed, and
the controlling means changes the display mode of the transaction object specified by the specifying means to be inconspicuous than the display mode in a case of not being specified by the specifying means.

20. The information processing apparatus according to claim 13,
wherein the specifying means specifies the transaction objects whose reference list deletion information is stored in the storing means, among the plurality of transaction objects to be listed, and
the controlling means changes the display mode of the transaction object specified by the specifying means to be inconspicuous than the display mode in a case of not being specified by the specifying means.
